(19) United States
(12) Patent Application Publication
(10) Pub. No.: US 2025/0346099 A1
(43) Pub. Date: Nov. 13, 2025

(54) FRAME DEVICE FOR A VEHICLE BODY OR A VEHICLE ROOF WITH A CABLE GUIDE FOR A DRIVE CABLE

(71) Applicant: Webasto SE, Stockdorf (DE)

(72) Inventor: Burkhard REINSCH, Stockdorf (DE)

(21) Appl. No.: 18/870,966

(22) PCT Filed: Jun. 26, 2023
(86) PCT No.: PCT/EP2023/067334

§ 371 Date: Dec. 2, 2024

(30) Foreign Application Priority Data
Jun. 27, 2022 (DE) 10 2022 115 903.5

(51) Int. Cl. B60J 7/02; B60J 7/06

(52) U.S. Cl. CPC B60J 7/022; B60J 7/06

(57) ABSTRACT

A frame device for a vehicle body or a vehicle roof with a cable guide for a drive cable with which a component which is mounted movably on the vehicle is adjustable, wherein the cable guide has guide segments which, with their supporting regions, support a guide tube, which is inserted on the cable guide and receives the drive cable, in the axial direction of said guide tube alternately on opposite sides in the radial direction, wherein the guide segments of the one side are offset in relation to one another in the radial direction relative to the guide segments of the other side in such a manner that the guide tube is held on the cable guide with a course following a sinuous line.

### CROSS-REFERENCE TO RELATED APPLICATIONS

This application is a U.S. national phase application filed under 35 U.S.C. § 371 of International Application No. PCT/EP2023/067334, filed on Jun. 26, 2023,published under WO 2024/002976 A1 on Jan. 4, 2024, designating the United States, which claims priority from German Patent Application Number 10 2022115 903.5, filed on Jun. 27, 2022, which are hereby incorporated herein by reference in their entirety.

### FIELD

A frame device for a vehicle body or a vehicle roof with a cable guide for a drive cable, by means of which a component mounted movably on the vehicle, such as a movably mounted cover of a sliding roof module or a roller-blind device, is adjustable, wherein the cable guide has guide segments which, with their supporting regions, support a guide tube, which is inserted on the cable guide and receives the drive cable, alternately in the axial direction of said guide tube on opposite sides in the radial direction.

### BACKGROUND

A frame device of the type in question is known from EP 2 072 303 A1. A cable guide has guide segments which, with their supporting regions, support a guide tube, which is inserted on the cable guide and receives the drive cable, alternately in the axial direction of said guide tube on opposite sides in the radial direction. The guide tube is held on the cable guide by means of the guide segments in such a way that its course follows a guide center line that extends continuously along a straight line or, in the region with a bend in its course, with a steady curvature.

Guide tubes made of plastic are inserted on plastic parts produced by injection molding, e.g. on a frame of a sliding roof unit, in guide channels and there form a homogeneous uninterrupted guide in which a drive cable is guided under tensile and compressive loading. The guide channels for receiving the guide tubes can be removed alternately from the injection mold at low cost. The guide tubes are then pushed into the guide channels formed.

To enable the plastic tubes to be inserted into the guide channels, these must be embodied with little play relative to one another on account of the production tolerances both of the tube and of the channel. However, this play then allows a movement of the guide tubes relative to the channel walls of the guide channels when the guide tubes are subjected to forces in the transverse direction or radial direction by the internal drive cable. This occurs, on the one hand, simply by virtue of the fact that the course of the guide tubes in the guide channels is generally embodied with at least one guide curve or guide arc in order to produce the connection between a drive motor arranged on a transverse frame part and the lateral, longitudinally extending guide rails for the movable mounting of a cover. On the other hand, the drive cables also have play in the guide tubes, which leads to radial deflection thereof when subjected to a compressive load and, as a result, they exert a force in the transverse direction on the guide tubes. The resulting transverse movement of the guide tubes in the guide channels leads to impact noises of the guide tubes on the channel walls. This is repeated with each change in the direction of force on the internal drive cable. Another effect that occurs is that a radial movement of the guide tube in the guide channel also results in a movement of the guide tube relative to the guide channel in the longitudinal direction. During this process, the guide tube and the channel wall rub against one another, and this may give rise to creaking noises. This is generally prevented by applying antifriction agents (grease, an antifriction coating, etc.), special pairs of materials or by additionally fixing the guide tubes with adhesive or mechanically in some portion or portions. These measures give rise to costly additional expenditure.

Typically, rattling noises occur in relatively long, approximately rectilinear regions of the cable guides or in regions with a slight curvature or even in regions of the cable guide in which the contact points between the drive cable and the cable guide change significantly, in particular during the shifting of the drive cable, which may occur, for example, when there is a change from a quick to a slow driving speed of the drive cable. Moreover, a load changeover of the drive cable, e.g. tension-compression changeover or in the case of a changeover from high load to low load, can lead to such rattling noises.

FR 2 696 515 A1, US 2011/0 278 882 A1 and EP 2 093 438 B1 form additional prior art.

### SUMMARY

The present embodiments provide a frame device specified at the outset which, in light of the stated disadvantages, is configured with a view to improved guidance of the drive cable. This object is achieved by a frame device having the features of claim 1. Advantageous embodiments of the invention are specified in the dependent claims.

According to the invention, the guide segments on one side are arranged offset in relation to one another in the radial direction relative to the guide segments on the other side in such a manner that the guide tube is held on the cable guide with a course following a sinuous line.

On account of the radial offset of the guide segments or of supporting regions of the guide segments, the guide tubes are each distorted slightly in the form of a sinuous line from guide segment to guide segment. Between the supporting regions on the guide segments, this sinuous deformation is imposed on the guide tube during installation by insertion into the guide channel formed by the guide segments, during which process the radial play is eliminated. The guide tube acquires a radial prestress relative to the guide channel. On account of the preloading force, this prestress produces frictional engagement on the guide segments of the guide channel, thereby preventing longitudinal displacement of the guide tube relative to the guide channel or guide segments.

This eliminates additional measures such as greasing of the guide tubes or the use of more expensive materials that enable relative sliding without noise, or fixing of the guide tube and the guide channel relative to one another by adhesive bonding or other mechanical locking means.

Such a drive cable of the frame device is, for example, a spiral cable which has a core that is stiff in tension and compression and a coil surrounding the core, which is surrounded by a cable sheath. The drive cable is expediently in engagement with a drive pinion of a drive motor and is longitudinally adjustable along the cable guide. A drive cable of this kind is known from DE 10 2015 104 068 A1 and from DE 10 2018 125 647 A1, for example.

Such a frame device is, for example, part of a frame of a sliding roof module, which is provided for installation in a roof opening of a vehicle roof. The frame device is, in particular, a transverse frame part which connects two lateral longitudinal frame parts of the sliding roof module to one another. A sliding roof module forms a component that is movably mounted on the vehicle and is movable by means of a bearing device that can be adjusted by the drive cable. The movably mounted component can furthermore also be a roller-blind device or some other component to be adjusted.

Moreover, the frame device according to the invention can be designed in such a way that the supporting regions of the guide segments on one side and on the other side have respective center lines which are arranged in a manner radially offset in relation to one another.

In this context, the frame device according to the invention can be implemented in such a way that the respective center line of a respective supporting region is formed by a cylinder axis of an approximately semi-cylindrical inner contour of the supporting region.

In addition, the frame device according to the invention can be implemented in such a way that the supporting regions of the guide segments on one side and on the other side are arranged radially in such a way that the center lines thereof are offset by a center offset, preferably an equal center offset, with respect to a reference center line of a guide channel—formed by the guide segments—of the cable guide.

Furthermore, the frame device according to the invention can be designed in such a way that the respective radial center offset of the respective supporting regions relative to the reference center line is 0.1 mm to 0.3 mm, and/or the center offset of two adjacent opposite supporting regions relative to one another is 0.2 mm to 0.6 mm.

Moreover, provision can be made for the guide segments on one of the two sides to be arranged with their supporting regions offset radially toward the reference center line of a guide channel—formed by the guide segments—of the cable guide. As an alternative, provision can be made for both the guide segments on one of the two sides and the guide segments on the opposite, other side to be arranged with their supporting regions offset radially toward the reference center line. Such a reference center line runs centrally and continuously and without an alternate radial offset of the guide segments in a cable guide. The reference center line is thus the center line of a guide tube which is held without deformation in the form of a sinuous line.

In particular, it is envisaged that the guide segments or the supporting regions hold the guide tube with a cross-sectional shape that remains constant over its course. The guide tube is thus held in the guide channel without the formation of a local constriction or squeezing.

Provision is expediently made for the supporting regions to hold the guide tube without play and by means of frictional engagement on the supporting regions so that it is fixed in a stationary position in the axial direction. Since axial relative movements between the guide tube and the supporting regions are prevented, one cause of possible creaking noises is eliminated.

One preferred embodiment envisages that each guide segment has a radial set-back portion at its end of the supporting region facing a free space between two adjacent guide segments arranged on the same side. Such a set-back portion is formed as a semi-annular radial extension, for example. Contact between the guide tube and the guide segment at its end facing the free space is thereby avoided. Sharp-edged flash that may arise during injection molding in an injection mold is then formed at most in a position on the guide segment such that disadvantageous contact with the guide tube is excluded.

The guide segments are expediently produced with the frame device by injection molding or plastic injection molding in an injection mold having two mold halves. The guide segments can also be secured as independent components on the frame device, e.g. by adhesive bonding, screw fastening or by means of latching connections.

### BRIEF DESCRIPTIONS OF THE DRAWINGS

A frame device according to the invention is explained in more detail below by means of an exemplary embodiment with reference to the drawing. In the drawing:

FIG. 1 shows an isometric view of a frame device of a sliding roof module of a vehicle roof;

FIG. 2 shows an enlarged isometric view of a detail of the frame device illustrated in FIG. 1 with guide channels and guide tubes inserted therein;

FIG. 3 shows a plan view of a guide channel;

FIG. 4 shows a longitudinal section according to section line A-A of FIG. 3 of the guide channel with a guide tube inserted therein;

FIG. 5 shows a cross-sectional view according to section line B-B of FIG. 3 of the guide channel with the guide tube inserted therein; and

FIG. 6 shows an enlarged cross-sectional view of a guide segment of the guide channel.

### DETAILED DESCRIPTION

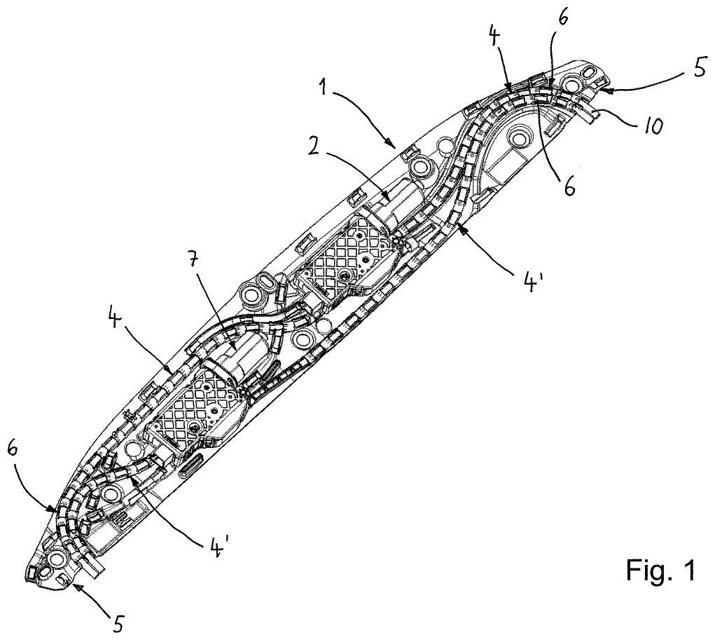

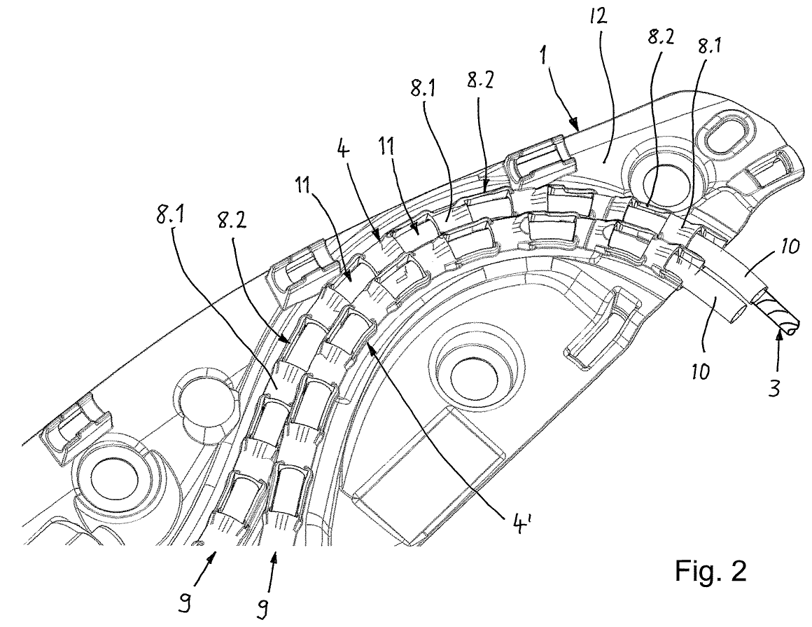

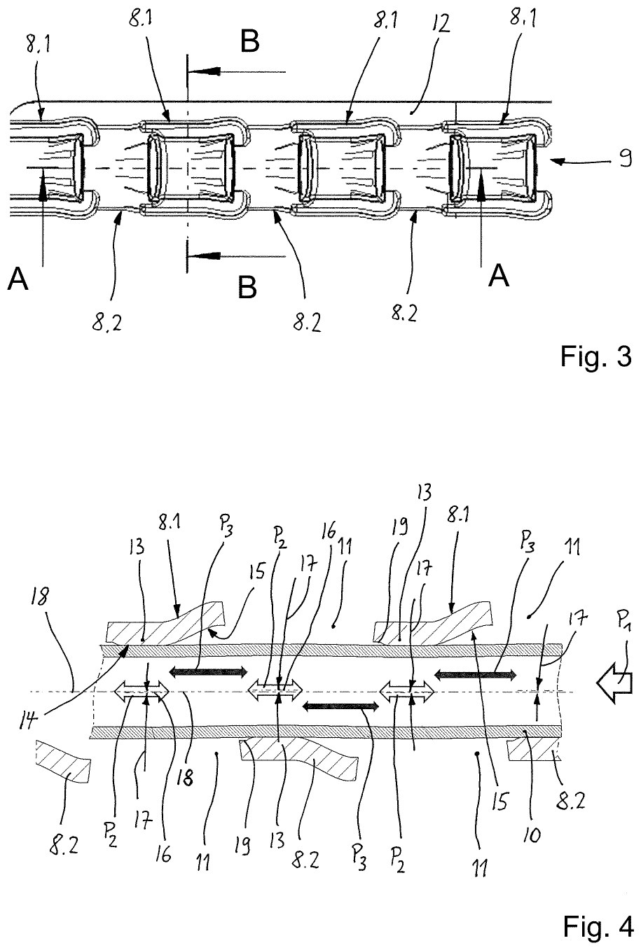

A frame device 1 (FIG. 1) of a sliding roof module which is provided for installation in a roof opening of a vehicle roof, forms a transverse frame part which connects two lateral longitudinal frame parts of the sliding roof module to one another. The frame device 1 may be either a front transverse frame part or a rear transverse frame part. A sliding roof module of this kind is known from DE 102008 064 548 A1, for example. Each of the two longitudinal frame parts contains a guide rail. A cover of the sliding roof module is mounted on the guide rails by means of a respective bearing device and is movable along the guide rails by means of a drive unit. The drive unit has a drive motor 2 arranged on the frame device 1. Each of the two bearing devices is connected to the drive motor 2 by a drive cable 3 (illustrated by way of example in FIG. 2). Each drive cable 3 is known as a spiral cable, for example. The drive cable 3 is in engagement with a drive pinion of the drive motor 2, enabling the drive cable 3 to be moved for longitudinal adjustment. A drive cable 3 of this kind is known from DE 10 2015104 068 A1 and also from DE 10 2018 125 647 A1, for example.

The frame device 1 has two cable guides 4, which, starting from the drive motor 2, each run to one of the two lateral end regions 5 of the frame device 1 and, in the end region 5 form a guide arc 6, which forms a transition to the adjoining longitudinal frame part (not illustrated) and a cable guide arranged thereon. The frame device 1 has a second drive motor 7, from which two cable guides 4′ of this kind likewise run to the two lateral end regions 5. The second drive motor 7 is provided for the adjustment of a roller blind device mounted on the sliding roof module and, for this purpose, is connected via the drive cable to a tension bar, which is movably mounted on the guide rails of the two lateral longitudinal frame parts.

Each cable guide 4 has guide segments 8, which form a guide channel 9 for a guide tube 10. The guide segments 8 are arranged alternately on opposite sides of the guide channel 9. First guide segments 8.1 are arranged on the first side. Two adjacent first guide segments 8.1 are in each case spaced apart by a distance, a gap or a free space 11. Second guide segments 8.2 are arranged on the second side, which is situated opposite the first side. Two adjacent second guide segments 8.2 are in each case spaced apart by a similar free space 11 of this kind. The first guide segments 8.1 and the second guide segments 8.2 are offset in relation to one another in the axial direction of the guide channel 9 in such a way that a free space 11 is situated opposite each guide segment 8.

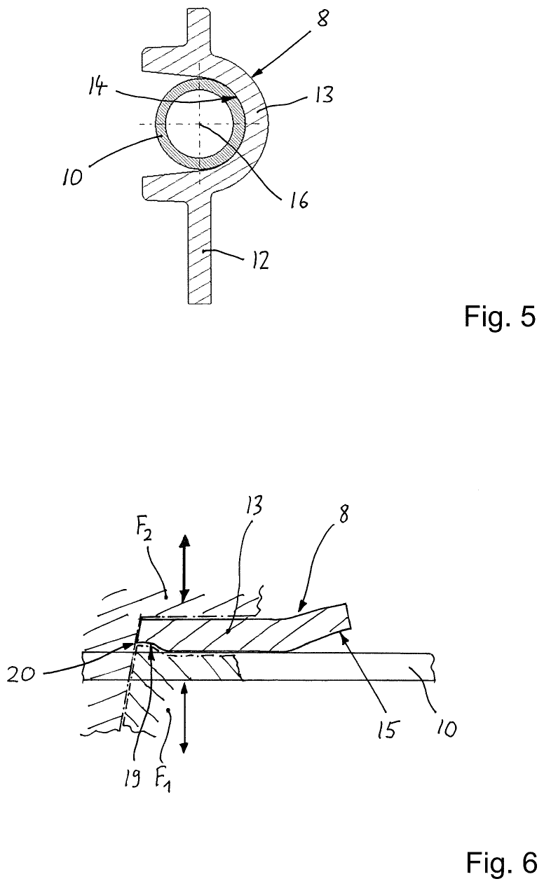

Each guide segment 8 is formed in a, for example plate-shaped, support structure 12 of the frame device 1 as a substantially half-shell-shaped part, which in each case opens to one of the two sides of the support structure 12 (FIG. 5). The support structure 12 with the guide segments 8 is preferably produced from plastic by injection molding in an injection mold.

Each guide segment 8 has a supporting region 13 with an approximately semi-cylindrical inner contour 14, which is matched to the cylindrical shape and size of the guide tube 10, ensuring that the guide tube 10 inserted into the guide channel 9 rests on the latter in surface contact. During its installation, the guide tube 10 is pushed axially into the guide channel 9 (installation direction according to arrow P₁ in FIG. 4). Each guide segment 8 contains a conically shaped run-in bevel 15, which is arranged ahead of the supporting region 13 in the installation or push-indirection.

The supporting regions 13 of the first guide segments 8.1 on one side are arranged offset in relation to one another in the radial direction relative to the supporting regions 13 of the second guide segments 8.2 on the other side in such a manner that the guide tube 10 is held on the cable guide 4 with a course following a sinuous line. In the case of a straight portion of the guide channel 9, a center line 16 of the respective supporting region 13, which forms the cylinder axis of the semi-cylindrical inner contour 14, is offset radially by a center offset 17 with respect to a reference center line 18, which runs as a straight line in a cable guide 4 with linear guidance or retention of the guide tube 10, in which the center line 16 of the supporting region 13 of each guide segment 8 does not have such a center offset. The center offset 17 of the supporting regions 13 is implemented in a corresponding manner in the case of curved or arched portions of the guide channel 9. In this way, the guide tube 10 acquires its sinuous course. The guide tube 10, which is preferably produced from plastic, is deformed accordingly.

The guide tube 10 acquires a radial prestress relative to the guide segments 8 of the guide channel 9, and it is therefore accommodated without radial play in the guide channel 9. This prestress generates frictional contact with the supporting regions 13 of the guide segments 8. As a result, longitudinal displacement of the guide tube 10 in the guide channel 9 is prevented. The cross-sectional shape of the guide tube 10 deformed in a sinuous line does not change. In particular, no narrowing of the guide tube 10 is produced.

The respective radial center offset 17 of the supporting regions 13 relative to the reference center line 18 is, for example, about 0.1 mm to 0.3 mm. The center offset 17 between two adjacent and opposite supporting regions 13 relative to one another is accordingly about 0.2 mm to 0.6 mm, which corresponds to the sum of the distance between the center offset 17 of the supporting region 13 of a guide segment 8 on one side from the reference center line 18 and the distance between the center offset 17 of the supporting region 13 of a guide segment 8 on the other, opposite side from the reference center line 18, or corresponds to the distance between the two center lines 16 of the opposite guide segments 8.

Each supporting region 13 forms only a first partial region of the guide segment 8 in the axial direction. The axial length of the respective supporting region is illustrated in FIG. 4 as a double arrow P₂. The run-in bevel 15 adjoining the supporting region 13 forms a second partial region of the guide segment 8, in which the guide tube 10 is not supported. The axial length of this free region, which does not offer any support, is illustrated in FIG. 4 as a double arrow P₃. As regions of transition to the supporting regions 13 or P₂, these free regions P₃ allow the bending deformation of the guide tube 10.

The axial length of each free region P₃ is, for example, about 7 mm to 10 mm for a guide tube 10 with a diameter of 8 mm and a wall thickness of 1 mm. P₃ is to be determined in accordance with the tube stiffness, which depends on the material and its elasticity or elastic modulus, the wall thickness and the diameter. In this region, the deformation of the guide tube 10 should take place without local “buckling” and without an excessive increase in the force for inserting the guide tube 10, which depends on the deformation work of the guide tube itself and on the frictional resistance due to the distortion.

The axial length of the supporting region 13 or P₂ is about 2 mm to 15 mm. In comparison with the axial length of the free region P₃, it is of relatively little significance for the desired distortion and has relatively little effect on the insertion force when inserting the guide tube 10. The length of P₂ is determined by the associated total length of the respectively unsupported region or free region P₃ of the guide tube 10. If this unsupported region of the guide tube 10 is too long, the guide tube 10 may be pushed out of the half-open guide channel 9 owing to high transverse forces acting on the guide tube 10, which may occur on account of the drive cable 3 even during normal operation or owing to inertia forces that act in crash situations.

At the end of its supporting region 13 facing the free space 11, each guide segment 8 has a radial set-back portion 19, which is in the form of semi-annular extension without contact with or support on the guide tube 10. The set-back portion 19 is formed by that mold half F₁ or F₂ of the injection mold (see FIG. 6, in which the directions of movement of the two mold halves are indicated by arrows) which projects through the free space 11 opposite the guide segment 8 when the injection mold is closed. If sharp-edged flash is formed at one edge 20 of the set-back portion 19 between the two mold halves F₁ and F₂ during the injection molding of the frame device 1 with the cable guides 4, such flash has no negative effects on the guide tube 10 owing to the lack of contact with the guide tube 10. The radial set-back portion 19 is about 0.2 mm to 0.5 mm, for example.

### LIST OF REFERENCE SIGNS

1 frame device
2 drive motor
3 drive cable
4 cable guide
5 end region
6 guide arc
7 drive motor
8 guide segment
8.1 guide segment
8.2 guide segment
9 guide channel
10 guide tube
11 free space
12 support structure
13 supporting region
14 inner contour
15 run-in bevel
16 center line
17 center offset
18 reference center line
19 set-back portion
20 edge

1. A frame device for a vehicle body or a vehicle roof with a cable guide for a drive cable, by means of which a component mounted movably on the vehicle is adjustable,
wherein the cable guide has guide segments that have supporting regions, which support a guide tube, which is inserted on the cable guide and receives the drive cable, alternately in the axial direction of said guide tube on opposite sides in the radial direction,
wherein characterized in that the guide segments on one side are arranged offset in relation to one another in the radial direction relative to the guide segments on the other side in such a manner that the guide tube is held on the cable guide with a course following a sinuous line.

2. The frame device as claimed in claim 1, wherein the supporting regions of the guide segments on one side and on the other side have respective center lines which are arranged offset in relation to one another.

3. The frame device as claimed in claim 2, wherein the respective center line of a respective supporting region is formed by a cylinder axis of an approximately semi-cylindrical inner contour of the supporting region.

4. The frame device as claimed in claim 2, wherein the supporting regions of the guide segments on one side and on the other side are arranged radially in such a way that the center lines thereof are offset by a center offset, preferably an equal center offset, with respect to a reference center line of a guide channel—formed by the guide segments of the cable guide.

5. The frame device as claimed in claim 4, wherein the respective radial center offset of the respective supporting regions relative to the reference center line is 0.1 mm to 0.3 mm, and/or the center offset of two adjacent opposite supporting regions relative to one another is 0.2 mm to 0.6 mm.

6. The frame device as claimed in claim 13, wherein the guide segments on one of the two sides are arranged with their supporting regions offset radially toward a reference center line of a guide channel formed by the guide segments of the cable guide, or
both the guide segments on one of the two sides and the guide segments on the opposite, other side are arranged with their supporting regions offset radially toward the reference center line.

7. The frame device as claimed claim 1, wherein the supporting regions hold the guide tube with a cross section that remains constant over its course.

8. The frame device as claimed in claim 1, wherein the supporting regions hold the guide tube without play and by means of frictional engagement on the supporting regions so that it is fixed in a stationary position in the axial direction.

9. The frame device as claimed in claim 1, wherein each guide segment has a radial set-back portion at its end of the supporting region facing a free space.

10. The frame device as claimed in claim 1, wherein the guide segments are produced with the frame device by injection molding in an injection mold having two mold halves.
